(19) United States
(12) Patent Application Publication
(10) Pub. No.: US 2012/0317480 A1
(43) Pub. Date: Dec. 13, 2012

(54) INFORMATION DISPLAY SYSTEM AND INFORMATION DISPLAY METHOD

(76) Inventor: Takahisa ONISHI, Osaka (JP)

(21) Appl. No.: 13/486,849

(22) Filed: Jun. 1, 2012

(30) Foreign Application Priority Data
Jun. 10, 2011 (JP) 2011-129721

(51) Int. Cl. G06F 17/21

(52) U.S. Cl. 715/273

(57) ABSTRACT

An image forming apparatus specifies, if a trouble occurs, a corresponding trouble code, generates a command including area specifying information corresponding to the trouble code, and transmits the command. A portable terminal receives the command and obtains the area specifying information therefrom, and displays a range of a manual specified by the area specifying information as an image. The range specified by the area specifying information is the range describing a method of fixing the trouble, and the area specifying information includes a text related to the trouble and a tag designating an attribute related to document configuration of the manual with respect to the text. Thus, a range describing the method of fixing the trouble is automatically displayed on the portable terminal, enabling a highly efficient trouble-shooting by a serviceman.

### CROSS-REFERENCE TO RELATED APPLICATION

This nonprovisional application claims priority under 35 U.S.C. §119(a) on Patent Application No. 2011-129721 filed in Japan on Jun. 10, 2011, the entire contents of which are hereby incorporated by reference.

### BACKGROUND OF THE INVENTION

1. Field of the Invention

The present invention relates to information display system and information display method for displaying information (such as a manual) related to electronic equipment such as an image forming apparatus, on a portable terminal.

2. Description of the Background Art

Recently, as one type of image processing apparatuses as electronic equipment, an image forming apparatus (typically a copy machine) for forming an image on a sheet of recording paper has been introduced to many places of business (companies and offices). In such a place of business, it is a common practice to have a plurality of image forming apparatuses having a printer function or copy function connected to a network and to share the apparatuses by a plurality of users. An MFP (MultiFunction Peripheral) as one type of such image forming apparatuses has a plurality of basic operational modes including a copy mode, a facsimile mode (hereinafter facsimile will be also denoted as FAX), a network compatible printer mode and a scanner mode.

In order to cut down expenses and to protect environment, reduction of paper resources has been encouraged and paperless-handling of materials is promoted. By way of example, manuals such as instruction booklets of electronic equipment including computers (hereinafter also referred to as PCs) and image forming apparatuses have been distributed to the purchasers. Recently, however, it is common to provide the manuals as electronic data in, for example, PDF format (in the following, such manuals may also be referred to as electronic manuals). It is possible for a user to display an operation method, a trouble-shooting method and the like for the apparatus on a display of a PC or on a liquid crystal display of an operation panel of an image forming apparatus for reference, as needed.

For instance, Japanese Patent Laying-Open No. 2003-198767 (hereinafter referred to as '767 Reference) discloses a method of storing a service manual of an image processing apparatus in a hard disk of the image processing apparatus and allowing a serviceman to update information in the service manual. This realizes a paperless service manual and allows timely updating of the service manual.

By this method, it is possible for the serviceman to update the manual in his good time. The updating operation, however, is troublesome for the serviceman. Further, at the time of trouble-shooting of the image processing apparatus, it is possible that the service manual is not of the latest version (containing not-yet-updated information), which may lead to a problem.

As a solution to such a problem, Japanese Patent Laying-Open No. 2010-219879 (hereinafter referred to as '879 Reference) discloses a system in which help information of a digital multifunctional peripheral as an object of service is acquired from a server and displayed on a portable telephone.

The system disclosed in '879 Reference, however, has a problem that sufficient information cannot be presented to the user, since a display panel of a portable telephone displaying the manual is generally small in size. Further, as the help information is transmitted from the server to the portable telephone in response to a request from the portable telephone, it is difficult to receive detailed information due to limited speed of communication. Further, it is necessary to newly form dedicated electronic data including help information and, therefore, it is difficult to effectively utilize an existing electronic manual.

### SUMMARY OF THE INVENTION

In view of the problems described above, it is desirable to provide user-friendly information display system and information display method including electronic equipment and a portable terminal linked to each other, enabling automatic display of a necessary part of a service manual of the electronic equipment on the portable terminal in accordance with the status of the electronic equipment and, particularly, when trouble occurs.

According to a first aspect, the present invention provides an information display system, including electronic equipment and a portable terminal having mounted therein electronic data of a manual of the electronic equipment. The electronic equipment includes: a storage unit storing trouble codes corresponding to types of troubles of the electronic equipment and pieces of area specifying information, in mutually corresponding manner; a trouble code specifying unit specifying, if a trouble occurs in the electronic equipment, a trouble code corresponding to the type of the trouble; a command generating unit generating a command including a piece of area specifying information corresponding to the specified trouble code; and a transmitting unit transmitting the command. The portable terminal includes: a receiving unit receiving the command transmitted from the electronic equipment; an obtaining unit obtaining the piece of area specifying information from the received command; and a display unit displaying a range of the manual specified by the obtained piece of area specifying information as an image. The range specified by the piece of area specifying information is a range describing a method of fixing the trouble. The piece of area specifying information includes a text related to the trouble, and a tag designating an attribute related to document configuration of the manual with respect to the text.

Preferably, the command includes a keyword related to the trouble, the obtaining unit obtains the keyword from the command, and the display unit displays the keyword included in the manual in an emphasized manner.

According to a second aspect, the present invention provides an information display system, including electronic equipment and a portable terminal having mounted therein electronic data of a manual of the electronic equipment. The electronic equipment includes: a trouble code specifying unit specifying, if a trouble occurs in the electronic equipment, a trouble code corresponding to the type of the trouble; and a transmitting unit transmitting the trouble code. The portable terminal includes: a storage unit storing trouble codes corresponding to types of troubles of the electronic equipment and pieces of area specifying information, in mutually corresponding manner; a receiving unit receiving the trouble code transmitted from the electronic equipment; an area specifying information specifying unit specifying a piece of area specifying information corresponding to the received trouble code; and a display unit displaying a range of the manual specified by the specified piece of area specifying information as an image. The range specified by the piece of area specifying information is a range describing a method of fixing the trouble. The piece of area specifying information includes a text related to the trouble, and a tag designating an attribute related to document configuration of the manual with respect to the text.

According to a third aspect, the present invention provides a method of displaying information on a portable terminal having mounted therein electronic data of a manual of electronic equipment. The method includes the steps of: the electronic equipment specifying, if a trouble occurs in the electronic equipment, a trouble code corresponding to the type of the trouble; the electronic equipment generating a command including a piece of area specifying information corresponding to the specified trouble code; the electronic equipment transmitting the command; the portable terminal receiving the command transmitted from the electronic equipment; the portable terminal obtaining the piece of area specifying information from the received command; and the portable terminal displaying a range of the manual specified by the obtained piece of area specifying information as an image. The electronic equipment stores trouble codes corresponding to types of troubles of the electronic equipment and pieces of area specifying information in mutually corresponding manner. The range specified by the piece of area specifying information is a range describing a method of fixing the trouble. The piece of area specifying information includes a text related to the trouble, and a tag designating an attribute related to document configuration of the manual with respect to the text.

According to a fourth aspect, the present invention provides a method of displaying information on a portable terminal having mounted therein electronic data of a manual of electronic equipment. The method includes the steps of the electronic equipment specifying, if a trouble occurs in the electronic equipment, a trouble code corresponding to the type of the trouble; the electronic equipment transmitting the trouble code; the portable terminal receiving the trouble code transmitted from the electronic equipment; the portable terminal specifying a piece of area specifying information corresponding to the received trouble code; and the portable terminal displaying a range of the manual specified by the specified piece of area specifying information as an image. The portable terminal stores trouble codes corresponding to types of troubles of the electronic equipment and pieces of area specifying information in mutually corresponding manner. The range specified by the piece of area specifying information is a range describing a method of fixing the trouble. The piece of area specifying information includes a text related to the trouble, and a tag designating an attribute related to document configuration of the manual with respect to the text.

According to the present invention, when a trouble occurs in the electronic equipment and the serviceman comes to the site for fixing the trouble, the information in the service manual related to the trouble can automatically be displayed on the serviceman's portable terminal. Therefore, it is possible for the serviceman to coop with the trouble with highly efficient manner.

The displayed information (screen image) is specified by tags of a computer language by which the existing electronic manual of the electronic equipment is described. Therefore, it is unnecessary to newly form a special electronic manual.

Since the range to be displayed is specified by using attributes (for example, chapter, section, item and paragraph) related to document configuration of the manual and description (texts) related to the trouble, as long as such information is included when the latest electronic manual is downloaded from the server to the portable terminal, it is possible to display information related to the trouble.

Since a keyword related to the trouble can be displayed in an emphasized manner, it becomes easier for a serviceman to refer to the service manual.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of the information display system in accordance with an embodiment of the present invention.

FIG. 2 is a perspective view showing an appearance of an image forming apparatus used in the information display system in accordance with the embodiment of the present invention.

FIG. 3 is a block diagram showing an internal configuration of the image forming apparatus shown in FIG. 2.

FIG. 4 is a front view showing an appearance of a portable terminal used in the information display system in accordance with the embodiment of the present invention.

FIG. 5 shows a table looked up when an instruction command is formed.

FIG. 6 is a flowchart representing a control structure of a program executed by the image forming apparatus of the information display system in accordance with the embodiment of the present invention.

FIG. 7 is a flowchart representing a control structure of a program executed by the portable terminal of the information display system in accordance with the embodiment of the present invention.

FIG. 8 shows an example of a screen image displayed on an operation unit of the image forming apparatus of the information display system in accordance with the embodiment of the present invention.

FIG. 9 shows an example of a screen image displayed on the operation unit of the image forming apparatus when a trouble occurs in the image forming apparatus of the information display system in accordance with the embodiment of the present invention.

FIG. 10 shows an example of a screen image displayed on a display unit of the portable terminal of the information display system in accordance with the embodiment of the present invention.

FIG. 11 shows an example of a screen image displayed on the display unit of the portable terminal, when the portable terminal of the information display system in accordance with the embodiment of the present invention receives an instruction command.

### DESCRIPTION OF THE PREFERRED EMBODIMENTS

In the following embodiment, the same components are denoted by the same reference characters. Their names and functions are also the same. Therefore, detailed description thereof will not be repeated.

The information display system in accordance with an embodiment of the present invention is formed of electronic equipment, a server computer (hereinafter referred to as a “server”) and a portable terminal device (hereinafter referred to as a “portable terminal”) connected to each other by a network. The electronic equipment is, for example, an image forming apparatus. In the following description, it is assumed that the electronic equipment is an image forming apparatus (digital multifunctional peripheral) having a plurality of functions including printer function, scanner function, copy function and facsimile function.

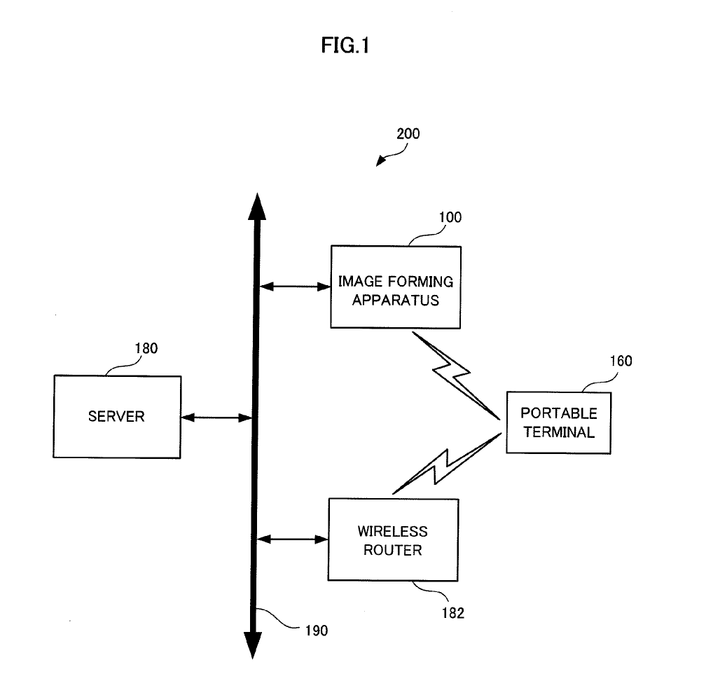

Referring to FIG. 1, an information display system 200 in accordance with the present embodiment includes an image forming apparatus 100, a portable terminal 160, a server 180, a wireless router 182, and a network to which these components are connected. Portable terminal 160 is a portable display device such as a PDA capable of displaying an electronic book or a smart phone. Server 180 exchanges information with image forming apparatus 100 and portable terminal 160. Wireless router 182 is a device for connecting portable terminal 160 to network 190. Information display system 200 may include, in addition to image forming apparatus 100, an image forming apparatus or apparatuses having comparable functions. In FIG. 1, however, only one apparatus is shown as a representative.

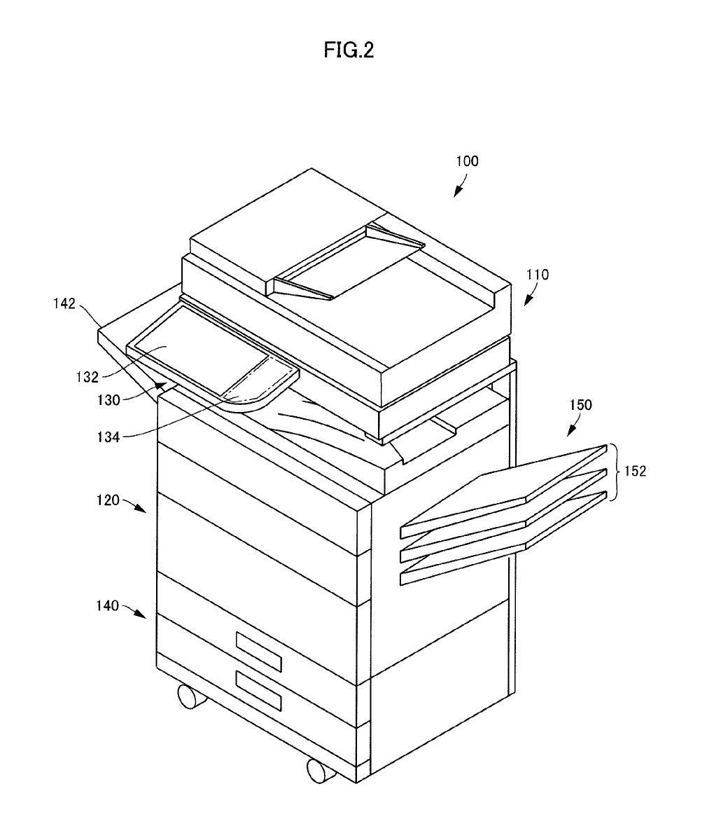

Referring to FIG. 2, image forming apparatus 100 includes a document reading unit 110, an image forming unit 120, an operation unit 130, a paper feed unit 140, a manual paper feed tray 142, and a paper discharge unit 150. Operation unit 130 includes a touch-panel display 132 and an operation key unit 134. Touch-panel display 132 includes a display panel implemented by a liquid crystal panel or the like, and a touch-panel arranged on the display panel and detecting a touched position. On operation key unit 134, a number of function keys, not shown, are arranged.

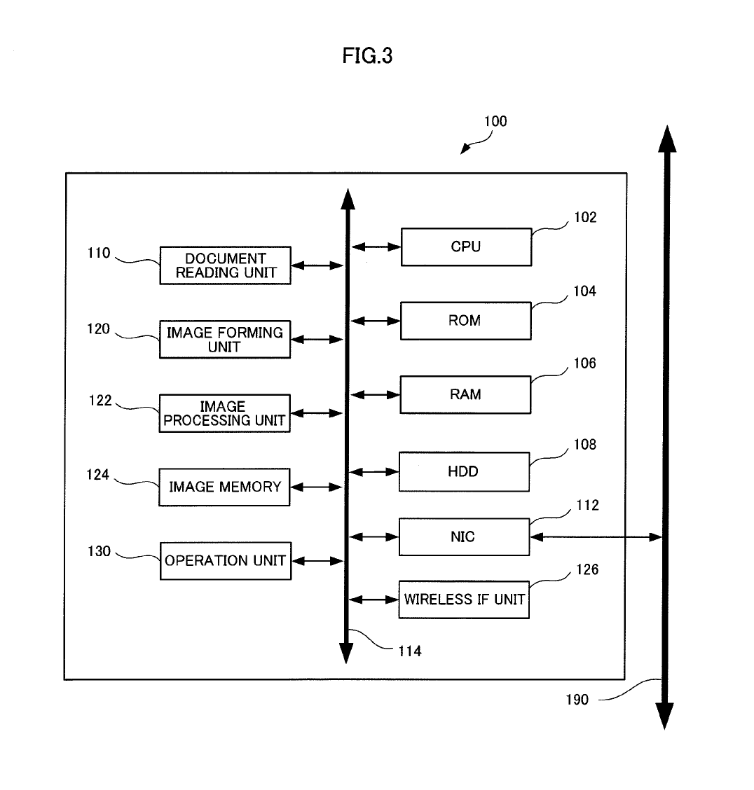

Referring to FIG. 3, image forming apparatus 100 includes: a control unit (hereinafter referred to as a CPU (Central Processing Unit)) 102 for overall control of image forming apparatus 100; an ROM (Read Only Memory) 104; an RAM (Random Access Memory) 106; and an HDD (Hard Disk Drive) 108. ROM 104 is a non-volatile storage device that retains data even when power is turned off. ROM 104 stores programs and data necessary for controlling operations of image forming apparatus 100. RAM 106 is a volatile storage device. HDD 108 is a non-volatile storage device.

Image forming apparatus 100 further includes an image processing unit 122, an image memory 124, an NIC (Network Interface Card) 112, a wireless interface unit (hereinafter referred to as wireless IF unit) 126, and a bus 114. CPU 102, ROM 104, RAM 106, HDD 108, NIC 112, wireless IF unit 126, document reading unit 110, image forming unit 120, image processing unit 122, image memory 124 and operation unit 130 are connected to bus 114. Data (including control information) are exchanged between these components and units through bus 114. CPU 102 reads a program from ROM 104 through bus 114 to RAM 106 and executes the program using a part of RAM 106 as a work area. Specifically, CPU 102 controls various components and units forming image forming apparatus 100 and realizes each of the functions of image forming apparatus 100 in accordance with a program or programs stored in ROM 104.

NIC 112 is connected to an external network 190, and it is an interface for image forming apparatus 100 to communicate with an external device through network 190. Image forming apparatus 100 includes a FAX modem (not shown) as an interface for image forming apparatus 100 to conduct FAX communication with an external device through a telephone line.

Wireless IF unit 126 is an interface for data exchange with portable terminal 160 and, by way of example, it is an interface for Bluetooth (registered trademark).

Document reading unit 110 includes a CCD (Charge Coupled Device) for reading an image, and a document detection sensor for detecting a document set on a platen or on an automatic document feeder (ADF). Document reading unit 110 reads the document and inputs image data. The image data is temporarily stored in image memory 124. Image processing unit 122 executes various image processing operations on the read image data. Image forming unit 120 prints image data on a sheet of recording paper. Image data is stored in HDD 108 as needed.

Paper feed unit 140 holds sheets of recording paper for forming images. Manual paper feed tray 142 is a tray for manually feeding sheets of recording paper.

Operation unit 130 receives inputs such as an instruction by the user to image forming apparatus 100. The user confirms the state and job processing status of image forming apparatus 100, from screen images displayed on touch-panel display 132. The user can set functions and instruct operations of image forming apparatus 100 by selecting keys displayed on touch-panel display 132 on the touch-panel superposed on the display panel (by touching the corresponding portions on the touch-panel).

CPU 102 monitors the user operation on touch-panel display 132, input keys and the like provided on operation unit 130, and displays pieces of information to be notified to the user, such as the information on the state of image forming apparatus 100, on touch-panel display 132.

Server 180 includes a CPU, an RAM, an ROM, an HDD and an NIC, as does a general purpose computer.

In the following, each of the modes for executing the functions available on image forming apparatus 100 (printer function, copy function, scanner function and facsimile function) will be briefly described.

(Printer Mode)

When image forming apparatus 100 is used as a printer, image data received through NIC 112 is output from image forming unit 120 through image memory 124 and the like.

NIC 112 receives, for example, image data from a computer connected to network 190. The received image data is transmitted page by page as output image data to image memory 124, and then stored in HDD 108. Thereafter, the image data stored in HDD 108 is successively read at appropriate timing and sent to image memory 124. Then, timed with image formation at image forming unit 120, the image data is transmitted to image forming unit 120.

At paper feed unit 140, a sheet of recording paper is drawn by a pick-up roller and conveyed by a plurality of conveyer rollers to image forming unit 120. At image forming unit 120, a charged photoreceptor drum is exposed in accordance with the input image data, whereby an electrostatic latent image corresponding to the image data is formed on a surface of photoreceptor drum. Toner is applied to the electrostatic latent image portions on the photoreceptor drum and, thereafter, the toner image is transferred to a sheet of recording paper. Thereafter, the sheet of recording paper is again heated and pressed (whereby the image is fixed on the sheet of paper), and then the sheet is discharged to paper discharge tray 152.

(Copy Mode)

When image forming apparatus 100 is used as a copy machine, image data of the document read by document reading unit 110 is output as a copy from image forming unit 120.

By the CCD provided at document reading unit 110, images of the document set at a reading position can be electronically read. The read image data is completed as output data (print data) on image memory 124, and stored in HDD 108. If there is a plurality of documents, the reading and storage operations are repeated. Thereafter, based on the process mode instructed from operation unit 130, the image data stored in HDD 108 is successively read at appropriate timing and transmitted to image memory 124. Then, as in the print mode described above, the image data is transmitted to image forming unit 120 and image formation takes place.

When the read image is to be printed on a plurality of pages, the image data is stored page by page as output data in the similar manner in HDD 108, transmitted from HDD 108 to image memory 124, and transmitted to image forming unit 120 timed with image formation, repeatedly for the number of pages to be output.

(Scanner Mode)

When image forming apparatus 100 is used, for example, as a network scanner, image data of the document read at document reading unit 110 is transmitted from NIC 112 through network 190 to a computer or the like. Here again, the document is electronically read by the CCD provided at document reading unit 110. The read image data is completed as output data on image memory 124, and stored in HDD 108. Thereafter, the image data is again transmitted from HDD 108 to image memory 124, and after communication with a transmission destination designated through operation unit 130 is established, transmitted from NIC 112 to the designated transmission destination.

(Facsimile Mode)

Image forming apparatus 100 can transmit/receive FAX to and from an external facsimile device through the FAX modem and telephone line.

When image forming apparatus 100 is used as a facsimile machine, data received by FAX from a facsimile machine is formed as image data on image memory 124, and in the similar manner as described above, storage in HDD 108 and printing by image forming unit 120 can be executed. Further, image forming apparatus 100 can read image data from HDD 108, convert the data to a data format for FAX communication and transmit the converted data to an external facsimile machine through the FAX modem and the telephone line.

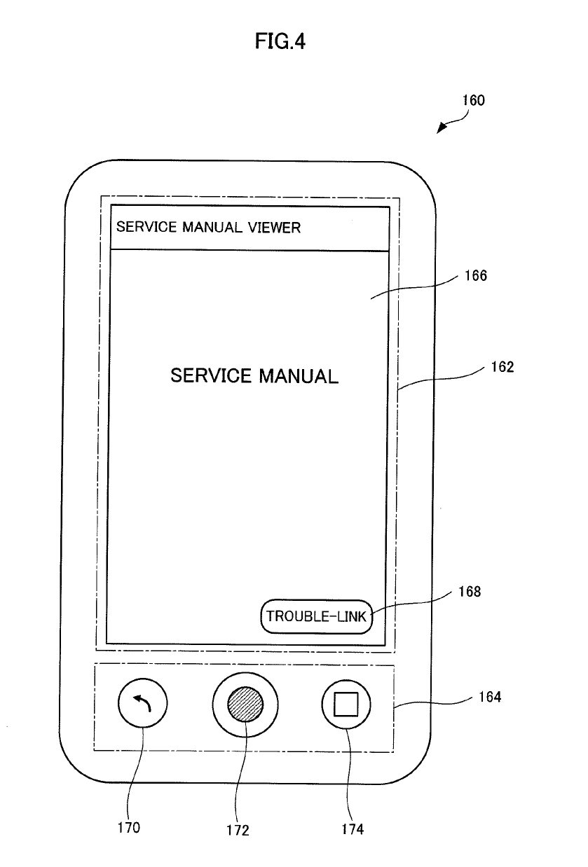

Referring to FIG. 4, portable terminal 160 is configured in the similar manner as a computer, and it includes a CPU, an ROM and an RAM (all not shown), and a display unit 162 and an operation key unit 164. Since portable terminal 160 must be compact and light-weight, it includes, as a non-volatile, rewritable storage, a semiconductor memory such as a flash memory. Here, it is assumed that portable terminal 160 has a flash memory, and that the flash memory stores electronic book data of a service manual.

Display unit 162 includes, similar to touch-panel display 132 of image forming apparatus 100, a display panel formed, for example, of a liquid crystal panel, and a touch-panel arranged on the display panel, for detecting a touched position. Operation key unit 164 is provided with a back key 170, a track ball 172 and a home key 174, as hardware. These keys are used for operating applications, specifically for operating displayed screen images. In FIG. 4, a screen image of front cover 166 of the service manual of image forming apparatus 100 is displayed on display unit 162. By operating the track ball, the user can feed forward the displayed page and display the next page, or feed backward and display the previous page. By pressing back key 170, the display can be returned to an immediately preceding page. Depending on application, it is possible to change the speed of feeding pages forward or backward in accordance with the speed of operation (speed of rotating the ball) of track ball 172. Home key 174 is a key for displaying a basic screen image and, when it is pressed, the currently displayed screen image is erased and the basic screen image is displayed. Since display unit 162 has the display panel and the touch-panel, it is also possible to display soft keys on display unit 162 and to cause portable terminal 160 to execute a prescribed function in accordance with a user operation of the soft keys.

Portable terminal 160 has an interface for Bluetooth and, through this interface, it exchanges data to/from image forming apparatus 100.

Portable terminal 160 has a wireless NIC and it accesses network 190 through wireless router 182. Portable terminal 160 accesses server 180 through wireless router 182, downloads electronic book data of the service manual from server 180, and stores the data in the flash memory. Portable terminal 160 may access server 180 periodically, so as to always have the latest electronic book data of the service manual.

In the following, the function of information display system 200 of displaying the service manual on portable terminal 160, when a trouble occurs in image forming apparatus 100 and a serviceman fixes the trouble at the site, will be specifically described.

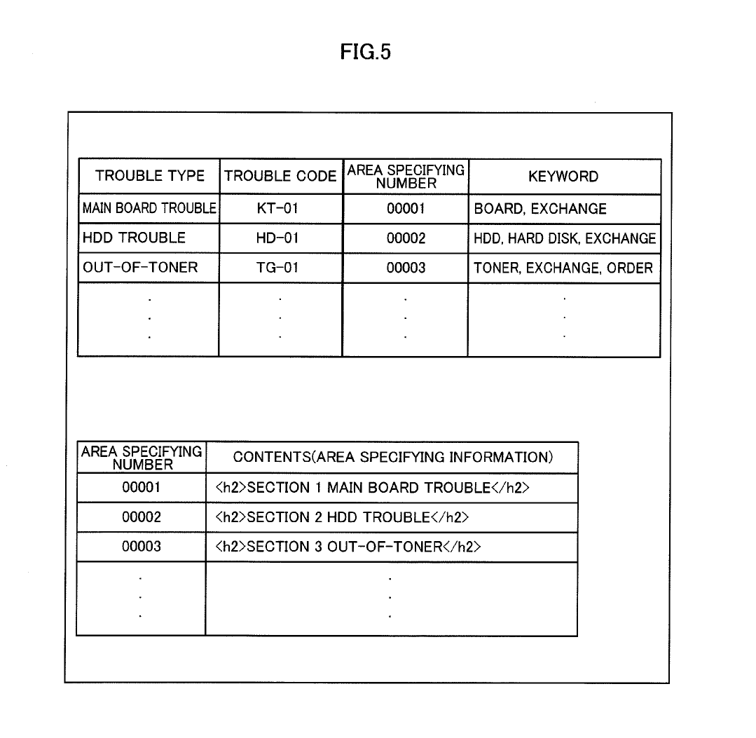

It is assumed as a precondition that pieces of information related to troubles of image forming apparatus 100 are stored in the HDD, as shown in FIG. 5. Specifically, “TROUBLE TYPE,” “TROUBLE CODE,” “AREA SPECIFYING INFORMATION” and “KEYWORD” are stored in mutually corresponding manner. In FIG. 5, a unique number (area specifying number) is added to each piece of area specifying information, and actual contents are stored in a separate table in relation to respective area specifying numbers.

The trouble type is represented by text data indicating what the trouble is. The trouble type is used for displaying a message related to the trouble on operation unit 130 of image forming apparatus 100, as will be described later. The trouble code represents a code (combination of letters, numbers and signs) uniquely allocated to each trouble type. Contents of the area specifying information are described using tags used in a computer language (for example, XHTML) in which the service manual is described. In FIG. 5, the contents are defined by tags <h2> and </h2> representing a header in XHTML and the text between these tags. The area specifying information is used for specifying a specific range (for example, a specific page) of the service manual corresponding to the trouble that has occurred, as will be described later. The keyword is text data including letters related to each trouble.

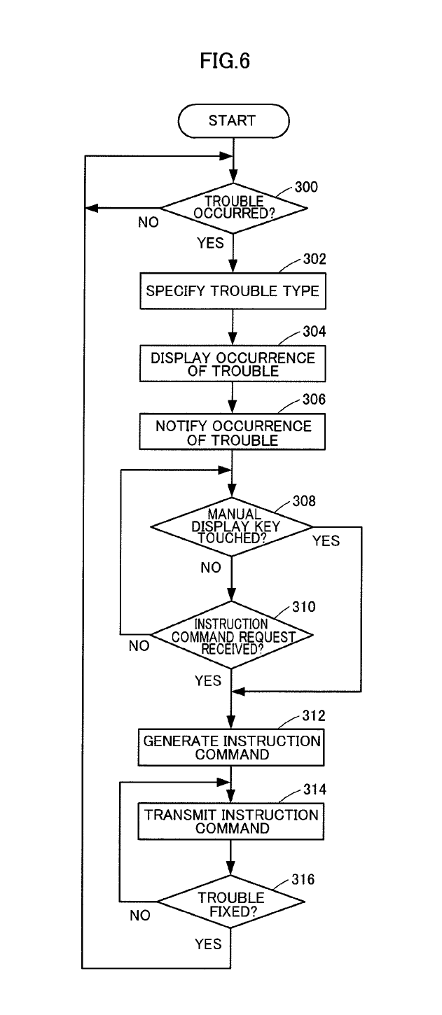

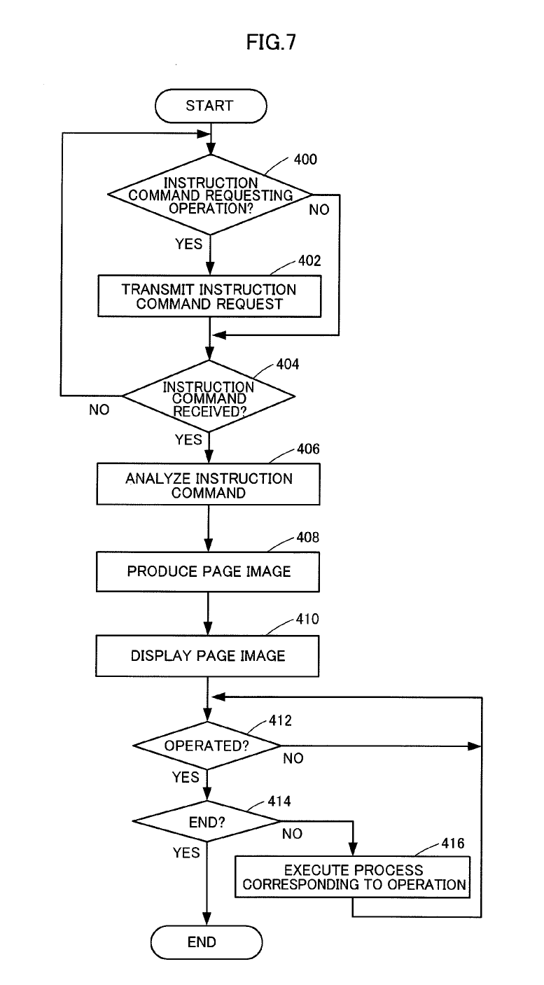

With the precondition as described above, control structures of programs executed by image forming apparatus 100 and portable terminal 160 in information display system 200 will be described with reference to FIGS. 6 and 7.

Referring to FIG. 6, at step 300 of the control structure of the program executed by image forming apparatus 100, CPU 102 determines whether or not any trouble has occurred in image forming apparatus 100 itself. The trouble means a state in which some or all of the functions provided by image forming apparatus 100 are unusable and, here, it mainly refers to a malfunction or the like that requires fixing by a serviceman. In image forming apparatus 100, sensors for detecting various troubles are provided, and from changes in signals from the sensors, occurrence of a trouble can be detected. By way of example, a sensor provided on a mechanism for holding a toner cartridge outputs a signal of which magnitude corresponds to the weight of each cartridge. Therefore, if the magnitude of the signal reaches a prescribed value or lower, CPU 102 can determine that out-of-toner trouble has occurred. If it is determined that a trouble has occurred, the process proceeds to step 302. Otherwise, the process of step 300 is repeated.

At step 302, CPU 102 identifies the trouble type. Specifically, CPU 102 determines the trouble code that corresponds to one or more sensors that detected signals representing the trouble. HDD 108 stores information specifying each sensor and the trouble code in relation to each other, in the form of a table. The corresponding relation may include correspondence between one sensor and one trouble code, and correspondence between a combination of sensors and one trouble code. For instance, if out-of-toner trouble occurs, CPU 102 identifies TG-01 as the trouble code.

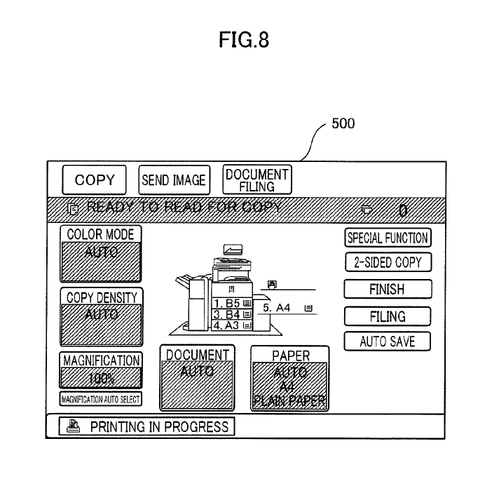

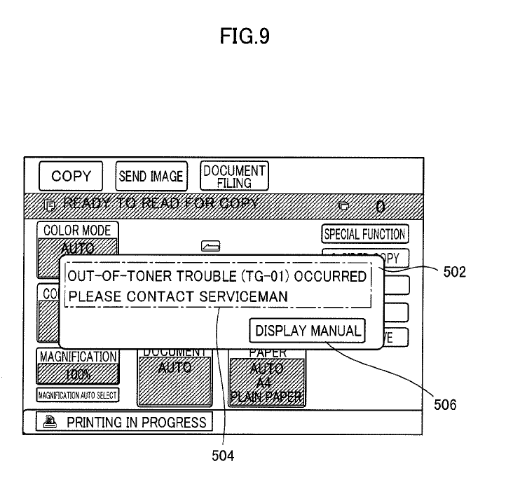

At step 304, CPU 102 displays occurrence of the trouble on operation unit 130. Specifically, using the trouble code determined at step 302, CPU 102 searches the table shown in FIG. 5 and reads the corresponding trouble type, and forms a message. CPU 102 displays the message superposed on the screen image currently displayed on operation unit 130. By way of example, when out-of-toner trouble occurs, CPU 102 reads “out-of-toner” as the trouble type corresponding to the trouble code TG-01 from the HDD. CPU 102 generates a message (image) using the trouble code and the read trouble type. CPU 102 superposes the generated message image data on the image data of the screen image displayed at present, on the image memory. For example, at step 302, assuming that a screen image 500 shown in FIG. 8 has been displayed on operation unit 130 immediately before detection of the trouble, a message box 502 is displayed as shown in FIG. 9. Message box 502 includes a message 504 including the trouble type and the trouble code, and a manual display key 506. In FIGS. 8 and 9, there is a display that printing is in progress, at a lower portion of screen image 500. FIG. 9 shows that the out-of-toner trouble occurred during execution of a print job. Looking at the message box 502, the user recognizes the necessity to contact the serviceman. Manual display key 506 will be described later.

At step 306, CPU 102 notifies server 180 of the occurrence of trouble. By way of example, CPU 102 transmits an electronic mail including the trouble code of the trouble that has occurred to a mail address registered in advance. In response to a service call from the user who noticed the message displayed at step 304, or a notice of trouble occurrence transmitted at step 306, a serviceman will be dispatched to the place where image forming apparatus 100 is installed.

At step 308, CPU 102 determines whether or not manual display key 506 displayed on operation unit 130 is touched. If it is determined to be touched, the process proceeds to step 312. Otherwise, the process proceeds to step 310.

At step 310, CPU 102 determines whether or not an instruction command request has been received. If it is determined to be received, the process proceeds to step 312. Otherwise, the process returns to step 308. Therefore, steps 308 and 310 are repeated until manual display key 506 is touched or a user instruction command request is transmitted from portable terminal 160, as will be described later. Touching the manual display key 506 or an instruction to cause portable terminal 160 to transmit the portable user instruction command request is made by the serviceman.

At step 312, using the trouble code determined at step 302, CPU 102 searches the table shown in FIG. 5 for the corresponding area specifying information and the keyword, and generates an instruction command including these. CPU 102 obtains an area specifying number corresponding to the trouble code from the table on the upper part of FIG. 5, and using the area specifying number, obtains the area specifying information from the table on the lower part. If the trouble code is TG-01, the instruction command includes “toner,” “exchange” and “order” as keywords, and further includes “<h2> Section 3 OUT-OF-TONER </h2>” as the area specifying information corresponding to the area specifying number 00003.

At step 314, CPU 102 transmits the instruction command generated at step 312 through wireless IF unit 126. The instruction command is transmitted to portable terminal 160 of the serviceman.

At step 316, CPU 102 determines whether or not the trouble has been fixed. If it is determined to be not yet fixed, the process returns to step 314. If it is determined that the trouble has been fixed, the process returns to step 300. For instance, after fixing by the serviceman, if the reset button of image forming apparatus 100 is pressed, CPU 102 can detect that the trouble has been fixed.

Referring to FIG. 7, the control structure of the program executed by portable terminal 160 will be described. Assume that the serviceman operates portable terminal 160 in the vicinity of image forming apparatus 100 in which the trouble has occurred, and the service manual is displayed on display unit 162 of portable terminal 160 (see FIG. 4). The following steps are executed in this state. Actually, each of the following steps is executed by a CPU inside portable terminal 160, utilizing, for example, the RAM and the like provided inside.

At step 400, portable terminal 160 determines whether or not an operation requesting an instruction command has been received. If it is determined that the operation has been received, the process proceeds to step 402. Otherwise, the process proceeds to step 404. Specifically, when a trouble-link key 168 shown in FIG. 4 is touched by the serviceman, portable terminal 160 determines that the operation requesting an instruction command has been received.

At step 402, portable terminal 160 transmits a prescribed instruction command request through an interface for Bluetooth. The instruction command request is transmitted to image forming apparatus 100.

At step 404, portable terminal 160 determines whether or not the instruction command is received from image forming apparatus 100. If it is determined that the command is received, the process proceeds to step 406. Otherwise, the process returns to step 400. Thus, steps 400 to 404 are repeated until trouble-link key 168 displayed on display unit 162 of portable terminal 160 is touched or manual display key 506 displayed on operation unit 130 of image forming apparatus 100 is touched and the instruction command is received.

At step 406, portable terminal 160 analyses the instruction command received at step 404 to obtain the area specifying information and the keywords. If out-of-toner trouble occurs, the instruction command includes “<h2> Section 3 OUT-OF-TONER </h2>” as the area specifying information and “toner,” “exchange” and “order” as keywords (see step 312). Thus, portable terminal 160 obtains “<h2> Section 3 OUT-OF-TONER </h2>” and “toner,” “exchange” and “order.”

At step 408, using the area specifying information obtained at step 406, portable terminal 160 searches the electronic book data of the service manual to find a page including the area specifying information. Portable terminal 160 reads data (XHTML data) describing the page of the electronic book of the service manual from the flash memory, and produces image data of the page on the internal RAM. At this time, portable terminal 160 produces the page image such that the text included in the area specifying information is displayed in an emphasized manner, by modifying the description data using a prescribed tag of XHTML. Modification of the description data is not made on the electronic book data of the service manual itself, but on that part of the electronic book data of the service manual which has been temporarily read to the RAM (description data of the page to be displayed). The page image is produced using the modified description data.

Further, portable terminal 160 searches the description data for producing the page image for the keywords obtained at step 404. If any keyword is included, portable terminal 160 produces the page image such that the keyword is displayed in an emphasized manner, by modifying the description data using a prescribed tag of XHTML, in the similar manner as described above.

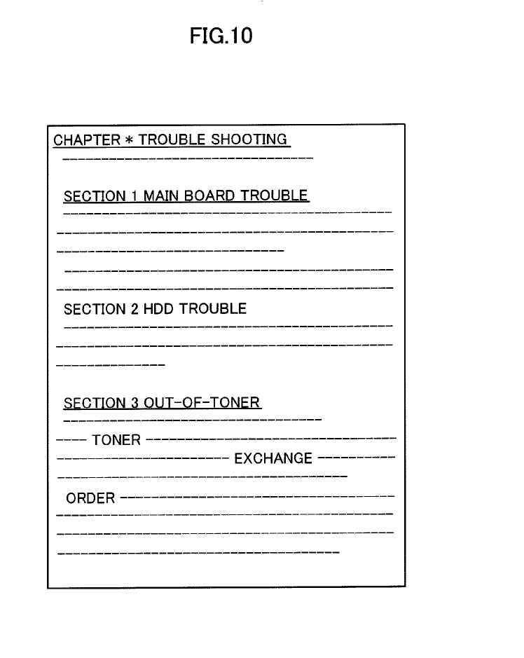

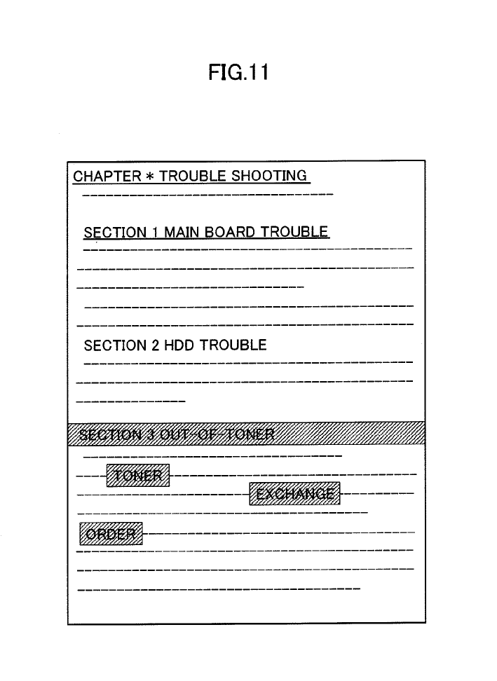

At step 410, portable terminal 160 displays the page image produced at step 408 on display unit 162. While the electronic book data of the service manual is typically displayed in such a manner as shown in FIG. 10, here, a page with emphasized display such as shown in FIG. 11 is displayed. Descriptions of the text color and the background color corresponding to the keywords and the letters included in the area specifying information are modified from the original electronic book data, so that the letters are displayed in highlighted manner in FIG. 11.

At step 412, portable terminal 160 determines whether or not any operation has been received. Step 412 is repeated until it is determined that any operation is received. If it is determined that any operation is received, the process proceeds to step 414.

At step 414, portable terminal 160 determines whether or not the operation at step 412 is an instruction to end. If it is determined to be an instruction to end, the present program ends. Otherwise, a process corresponding to the operation is executed at step 416, and the process returns to step 412. By way of example, a process of page feed, page return or the like is executed in response to a key operation on operation key unit 164, or a touch operation or gesture operation on display unit 162.

As described above, as the programs shown in FIGS. 6 and 7 are executed by image forming apparatus 100 and portable terminal 160, respectively, the information in the service manual related to the trouble can automatically be displayed on portable terminal 160 of the serviceman, when the serviceman is to fix the trouble of image forming apparatus 100. Thus, it becomes possible for the serviceman to address the trouble in a highly efficient manner.

In the foregoing, an example has been described in which the instruction command is transmitted if operation unit 130 of image forming apparatus 100 is operated (if manual display key 506 is touched) or if an instruction command request is issued from portable terminal 160 (if trouble-link key 168 is touched). The example, however, is not limiting. The instruction command may be transmitted automatically in case of trouble, even if no operation is received.

In the foregoing, an example has been described in which the instruction command is directly transmitted from image forming apparatus 100 to portable terminal 160. The example, however, is not limiting. If direct communication between image forming apparatus 100 and portable terminal 160 is impossible, image forming apparatus 100 may transmit the instruction command to server 180, and portable terminal 160 may obtain the instruction command from server 180 by downloading or by electronic mail. Troubles may occur simultaneously in a plurality of different image forming apparatuses 100. In order to cope with such a situation, instruction commands and pieces of information for identifying the image forming apparatuses may be stored in related manner in the HDD of server 180. Then, portable terminal 160 can obtain the corresponding instruction command by transmitting the information for identifying the image forming apparatus to server 180.

Though an example in which an instruction command including a piece of information for specifying the page related to the trouble is transmitted has been described above, the trouble code may be transmitted. In that case, the trouble codes, area specifying information and keywords such as shown in FIG. 5 may be stored in mutually corresponding manner in portable terminal 160. Then, portable terminal 160 can determine the area specifying information and the keyword or keywords from the trouble code. Alternatively, the serviceman may look at the trouble code displayed on operation unit 130 of image forming apparatus 100 and may input the trouble code by operating portable terminal 160, without necessitating transmission of the trouble code from image forming apparatus 100.

Alternatively, the trouble codes, area specifying information and keywords may be stored in server 180, and image forming apparatus 100 may transmit the trouble code to portable terminal 160 or server 180. If portable terminal 160 receives the trouble code, portable terminal 160 transmits the trouble code to server 180, and obtains the area specifying information and the keywords from server 180. If image forming apparatus 100 is to transmit the trouble code to server 180, the trouble codes and pieces of information for identifying the image forming apparatuses are stored in mutually corresponding manner in the HDD of server 180 as described above. By such an arrangement, it becomes possible for portable terminal 160 to transmit a piece of information for identifying the image forming apparatus to server 180 and to obtain the corresponding trouble code.

Though an example in which tags <h2> and </h2> for the header are used has been described above, other tags for the header (such as <h1> </h1>, <h3> </h3>) may be used.

Tags other than those for the header may be used. For example, tags designating attributes related to document configuration of text (such as chapter, section, item and paragraph) may be used.

The manner of emphasizing the display is not limited to highlighting such as shown in FIG. 11. Tags for designating the color of text, tags for making text bold, tags for increasing font size, or tags for making text italic may be used. Font type may be changed.

In the foregoing, an example has been described in which the service manual in the form of an electronic book is in page-format data described in XHTML. The service manual in the form of an electronic book may have any data format and may be described in any language. By way of example, possible data format includes XMDF (registered trademark), EPUB and PDF. Possible description language includes XML, XHTML and HTML.

Though an example has been described in the foregoing in which the page related to the trouble is displayed, the example is not limiting. A specific range of one page (a portion where information related to the trouble is described) may be displayed. By way of example, only a prescribed range of the service manual containing the area specifying information shown in FIG. 5 at the head may be displayed.

The information to be displayed is not limited to the information directly related to the trouble. The information may include information related to ordering of expendable supplies or maintenance parts. If a supply item or a maintenance part is to be ordered to cope with the trouble, a page including information related to the method of ordering the item or part may be displayed. In that case, an instruction command including a header (text) related to the method of ordering and a prescribed tag may be generated.

Though an example in which portable terminal 160 is connected to network 190 through wireless router 182 to communicate with server 180 has been described above, the example is not limiting. For instance, portable terminal 160 may be connected to the Internet through a base station of portable telephone to communicate with server 180.

In order to maintain the service manual of portable terminal 160 at the latest state, it is efficient to download latest service manual from server 180. Therefore, provision of server 180 is desirable. It is noted, however, that server 180 may not be provided if the instruction command or the trouble code can be transmitted from image forming apparatus 100 to portable terminal 160. That the portable terminal 160 is connectable to network 190 is not an indispensable requirement and it may not have wireless router 182.

Though it is preferred that portable terminal 160 has a liquid crystal panel of relatively large size (of 5.5 inches or larger), a portable telephone having smaller display screen may be used. If the page image displayed on the screen is small, the display may be enlarged.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. An information display system, including electronic equipment and a portable terminal having mounted therein electronic data of a manual of the electronic equipment, wherein
said electronic equipment includes
a storage unit storing trouble codes corresponding to types of troubles of the electronic equipment and pieces of area specifying information, in mutually corresponding manner,
a trouble code specifying unit specifying, if a trouble occurs in the electronic equipment, a trouble code corresponding to the type of the trouble,
a command generating unit generating a command including a piece of area specifying information corresponding to said specified trouble code, and
a transmitting unit transmitting said command;
said portable terminal includes
a receiving unit receiving said command transmitted from said electronic equipment,
an obtaining unit obtaining said piece of area specifying information from said received command, and
a display unit displaying a range of said manual specified by said obtained piece of area specifying information as an image;
said range specified by said piece of area specifying information is a range describing a method of fixing said trouble; and
said piece of area specifying information includes a text related to said trouble, and a tag designating an attribute related to document configuration of said manual with respect to said text.

2. The information display system according to claim 1, wherein
said command includes a keyword related to said trouble;
said obtaining unit obtains said keyword from said command; and
said display unit displays said keyword included in said manual in an emphasized manner.

3. An information display system, including electronic equipment and a portable terminal having mounted therein electronic data of a manual of the electronic equipment, wherein
said electronic equipment includes
a trouble code specifying unit specifying, if a trouble occurs in the electronic equipment, a trouble code corresponding to the type of the trouble, and
a transmitting unit transmitting said trouble code;
said portable terminal includes
a storage unit storing trouble codes corresponding to types of troubles of the electronic equipment and pieces of area specifying information, in mutually corresponding manner,
a receiving unit receiving said trouble code transmitted from said electronic equipment,
an area specifying information specifying unit specifying a piece of area specifying information corresponding to said received trouble code, and
a display unit displaying a range of said manual specified by said specified piece of area specifying information as an image;
said range specified by said piece of area specifying information is a range describing a method of fixing said trouble; and
said piece of area specifying information includes a text related to said trouble, and a tag designating an attribute related to document configuration of said manual with respect to said text.

4. A method of displaying information on a portable terminal having mounted therein electronic data of a manual of electronic equipment, comprising the steps of;
said electronic equipment specifying, if a trouble occurs in the electronic equipment, a trouble code corresponding to the type of the trouble;
said electronic equipment generating a command including a piece of area specifying information corresponding to said specified trouble code;
said electronic equipment transmitting said command;
said portable terminal receiving said command transmitted from said electronic equipment;
said portable terminal obtaining said piece of area specifying information from said received command; and
said portable terminal displaying a range of said manual specified by said obtained piece of area specifying information as an image; wherein
said electronic equipment stores trouble codes corresponding to types of troubles of the electronic equipment and pieces of area specifying information in mutually corresponding manner;
said range specified by said piece of area specifying information is a range describing a method of fixing said trouble; and
said piece of area specifying information includes a text related to said trouble, and a tag designating an attribute related to document configuration of said manual with respect to said text.

5. A method of displaying information on a portable terminal having mounted therein electronic data of a manual of electronic equipment, comprising the steps of;
said electronic equipment specifying, if a trouble occurs in the electronic equipment, a trouble code corresponding to the type of the trouble;
said electronic equipment transmitting said trouble code;
said portable terminal receiving said trouble code transmitted from said electronic equipment;
said portable terminal specifying a piece of area specifying information corresponding to said received trouble code; and
said portable terminal displaying a range of said manual specified by said specified piece of area specifying information as an image; wherein
said portable terminal stores trouble codes corresponding to types of troubles of said electronic equipment and pieces of area specifying information in mutually corresponding manner;
said range specified by said piece of area specifying information is a range describing a method of fixing said trouble; and
said piece of area specifying information includes a text related to said trouble, and a tag designating an attribute related to document configuration of said manual with respect to said text.
